(19) United States
(12) Patent Application Publication
(10) Pub. No.: US 2024/0302671 A1
(43) Pub. Date: Sep. 12, 2024

(54) METHODS, DEVICES, AND SYSTEMS FOR AUGMENTED REALITY

(71) Applicant: TENCENT AMERICA LLC, Palo Alto, CA (US)

(72) Inventors: Yu Ji, New York, NY (US); Changxi Zheng, New York, NY (US); Jinwei Ye, New York, NY (US)

(73) Assignee: TENCENT AMERICA LLC, Palo Alto, CA (US)

(21) Appl. No.: 18/210,717

(22) Filed: Jun. 16, 2023

Related U.S. Application Data
(60) Provisional application No. 63/450,258, filed on Mar. 6, 2023.

(51) Int. Cl. G02B 27/28; G02B 27/01

(52) U.S. Cl. CPC G02B 27/286; G02B 27/0101; G02B 27/0172; G02B 2027/0138; G02B 2027/014; G02B 2027/0178

(57) ABSTRACT

Apparatus, system, and method for providing an augmented reality (AR) display. The system includes a panel comprising: a first linear polarizer configured to allow light from an object to transmit through as a polarized light; and a liquid crystal layer disposed on the first linear polarizer and at an opposite side with respect to the object, the liquid crystal layer comprising an array of liquid crystal pixels corresponding to AR content, each pixel configured to modify the polarized light; eyeglasses worn by a user and configured to directly receive the modified polarized light, at least one lens of the eyeglasses comprising a second linear polarizer; at least one camera configured to acquire at least one image of the user to obtain a face position of the user; and a controller configured to render the AR content based on the face position.

### INCORPORATION BY REFERENCE

This application is based on and claims the benefit of priority to U.S. Provisional Patent Application No. 63/450,258, filed on Mar. 6, 2023, which is herein incorporated by reference in its entirety.

### FIELD OF THE TECHNOLOGY

The present disclosure relates to augmented reality (AR), and in particular, to an AR display.

### BACKGROUND OF THE DISCLOSURE

Augmented reality (AR) can allow a person to simultaneously see real objects and virtual objects, for example, a picture or text displayed in real environment to the person's field of vision. Augmented reality can include information between real objects and virtual objects. Augmented reality has numerous potential applications in the fields of exhibition, description, and entertainment.

Recently, there has been considerable progress with AR display technologies. However, there are some issues/problems associated with some of these technologies, for example, expensive, bulky, and/or user-unfriendly. The present disclosure describes various embodiments for providing AR display, addressing at least one of the issues/problems discussed above, thus, improving AR technology.

### SUMMARY

The present disclosure describes various embodiments of methods, apparatus, system, and computer-readable storage medium for providing augmented reality (AR) display.

According to one aspect, an embodiment of the present disclosure provides an apparatus for providing an AR display. The apparatus includes a first linear polarizer configured to allow light from an object to transmit through as a polarized light; a liquid crystal layer disposed on the first linear polarizer and at an opposite side with respect to the object, the liquid crystal layer comprising an array of liquid crystal pixels corresponding to AR content, each pixel configured to modify the polarized light; and eyeglasses worn by a user and configured to directly receive the modified polarized light, at least one lens of the eyeglasses comprising a second linear polarizer.

According to another aspect, an embodiment of the present disclosure provides a system for providing an AR display. The system includes a panel comprising: a first linear polarizer configured to allow light from an object to transmit through as a polarized light; and a liquid crystal layer disposed on the first linear polarizer and at an opposite side with respect to the object, the liquid crystal layer comprising an array of liquid crystal pixels corresponding to AR content, each pixel configured to modify the polarized light; eyeglasses worn by a user and configured to directly receive the modified polarized light, at least one lens of the eyeglasses comprising a second linear polarizer; at least one camera configured to acquire at least one image of the user to obtain a face position of the user; and a controller configured to render the AR content based on the face position.

According to another aspect, an embodiment of the present disclosure provides a method for providing an AR display. The method includes providing a first linear polarizer configured to allow light from an object to transmit through as a polarized light; disposing a liquid crystal layer on the first linear polarizer and at an opposite side with respect to the object, the liquid crystal layer comprising an array of liquid crystal pixels corresponding to AR content, each pixel configured to modify the polarized light; and providing eyeglasses to be worn by a user and configured to directly receive the modified polarized light, at least one lens of the eyeglasses comprising a second linear polarizer.

In some other embodiments, an apparatus may include a memory storing instructions and a processing circuitry in communication with the memory. When the processing circuitry executes the instructions, the processing circuitry is configured to carry out the above methods.

In some other embodiments, a system may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium includes a non-transitory computer-readable medium.

The above and other aspects and their implementations are described in greater detail in the drawings, the descriptions, and the claims.

### BRIEF DESCRIPTION OF THE DRAWINGS

FIG. 1A is a schematic diagram of an exemplary embodiment disclosed in the present disclosure.

FIG. 1B is a schematic diagram of another exemplary embodiment disclosed in the present disclosure.

FIG. 2A is a schematic diagram of a pixel unit in an exemplary embodiment disclosed in the present disclosure.

FIG. 2B is an illustration view of an exemplary embodiment disclosed in the present disclosure.

FIG. 3 is a flow diagram of an embodiment disclosed in the present disclosure.

FIG. 4 is a schematic diagram of an electronic device disclosed in the present disclosure.

### DETAILED DESCRIPTION OF THE DISCLOSURE

The invention will now be described in detail hereinafter with reference to the accompanied drawings, which form a part of the present invention, and which show, by way of illustration, specific examples of embodiments. Please note that the invention may, however, be embodied in a variety of different forms and, therefore, the covered or claimed subject matter is intended to be construed as not being limited to any of the embodiments to be set forth below. Please also note that the invention may be embodied as methods, devices, components, or systems. Accordingly, embodiments of the invention may, for example, take the form of hardware, software, firmware or any combination thereof.

Throughout the specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for providing augmented reality (AR) display.

Augmented reality (AR) can allow a person to simultaneously see real objects and virtual objects, for example, a picture or text displayed in real environment to the person's field of vision. Augmented reality can include information between real objects and virtual objects. Augmented reality has numerous potential applications in the fields of exhibition, description, and entertainment.

Recently, there has been considerable progress with AR display technologies. However, there are some issues/problems associated with these technologies, for example, expensive, bulky, and/or user-unfriendly. The present disclosure describes various embodiments for providing AR display, addressing at least one of the issues/problems discussed above, improving AR technology.

For example, some AR glasses are wearable devices for displaying AR contents. It includes glasses frame, optical elements, microcomputer, power, and sensors. To create AR effect, this device generates the virtual content and projects the images to the glasses through its optical elements. To mix the AR content with the real-world, AR glasses requires highly accurate 3D localization and scene understanding, so additional sensors, such as camera and depth sensor, are required for capturing the scene, and then on-board computing unit uses the data for 3D position and orientation estimation. In the end, the user can watch the AR content in front of eye and the real-world scene through the glasses.

In some implementations, a transparent TV is a new type of display device which use OLED technology for displaying visual contents. This TV is made with an OLED layer which is sandwiched by multiple film/glass layer for contrast enhancement and protection purposes. Since the OLED can be lit individually, this transparent TV doesn't require backlight, which is common for traditional LCD/LED TV/monitors. The OLED can be constructed on the glass, so the entire TV display panel can be made to be transparent.

The present disclosure describes various embodiments for providing AR display with an AR display panel to improve AR display modes. The AR display panel may be viewed as same as normal glass, appearing to be transparent to naked eyes. This AR display may be widely used in museum, shopping center and exposition for object exhibition, description, and entertainment. Under normal circumstances, a user (e.g., a spectator to a museum or a customer to a shopping mall) may see-through the AR panel and look at the scene/objects placed behind the AR panel. When the user wears a pair of special eyeglasses, the user may see AR content which is displayed on the AR display panel and is superimposed on the scene/objects behind the AR display panel.

As non-limiting examples of applications, the various embodiments in the present disclosure may be used for product showcase, museum's cultural or specimen demonstration, commodity exhibition. For the museum, the AR display can enrich the demonstration by adding more object information (like item's place of origin, size, weight, and introduction video, etc.) on the AR panel. People without wearing the glasses can view the items normally, while the user with the glasses can see these add-on contents. Unlike printed information, this AR display can display dynamic content according to the exhibition in real time. With this technology, museum can remove or reduce text boards and/or normal display screens to reduce cost and save space.

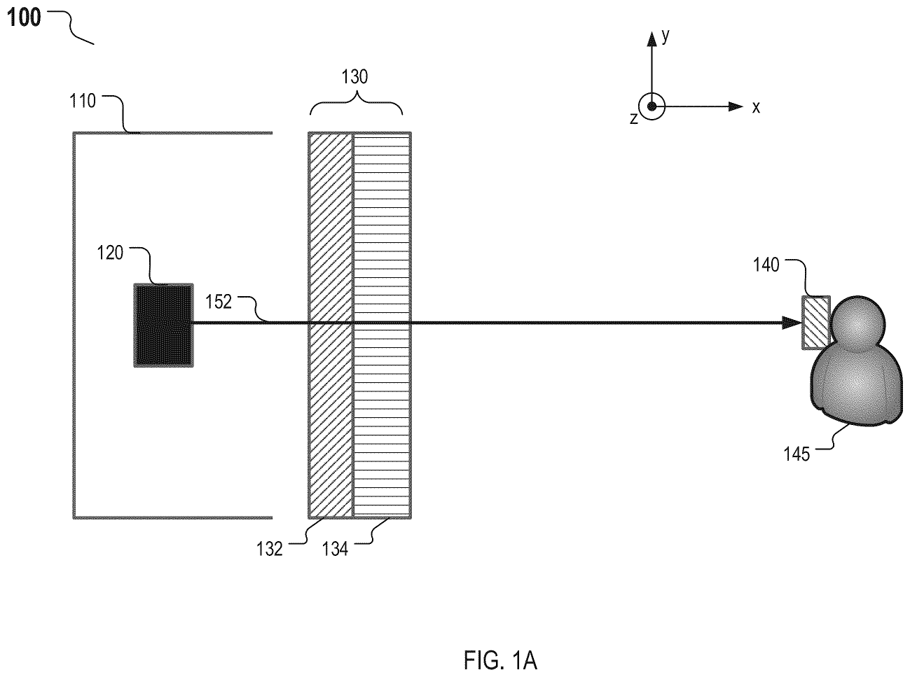

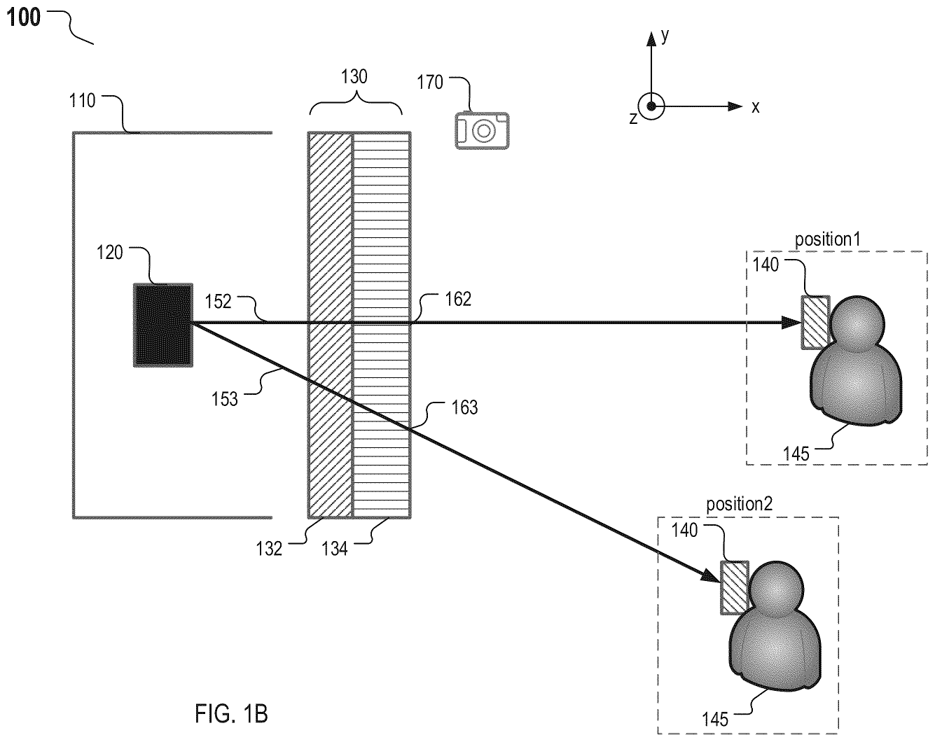

Referring to FIG. 1A, a device 100 provides an AR display corresponding to a real object 120 for a user 145. The device 100 may include a portion or all of the following: a soft light box 110, an AR glass panel (or simply a panel or AR panel) 130, and a pair of eyeglasses (or simply eyeglasses or glasses) 140. The AR glass panel may include a linear polarizer 132 and a liquid crystal layer 134. In some implementation, the device 100 may include a controller, which provide control signal and data to the AR glass panel to display AR content.

The soft light box may provide a white light illumination on the object, and the light (for example, a light 152) from the object may pass through the linear polarizer 132 to become a linear polarized light. In some implementations, the object itself may be a light source and capable of emitting its own light. The linear polarizer may have a linear polarization along horizontal direction (i.e., along y-axis), or along vertical direction (i.e., along z-axis), or 45-degree to y-axis in the y-z plane.

The linear polarized light after the linear polarizer 132 passes through the liquid crystal layer 134.

The liquid crystal layer 134 is disposed on the linear polarizer 132 and maintain direct contact with the linear polarizer 132. The liquid crystal layer 134 is disposed at a different side from the object 120 with respect to the linear polarizer 132, for example, the object 120 is at negative x direction of the linear polarizer 132, and the liquid crystal layer 134 is at a positive x direction of the linear polarizer 132. The liquid crystal layer 132 may comprise an array of liquid crystal pixels corresponding to AR content, each pixel of the pixel array is configured to modify the polarized light.

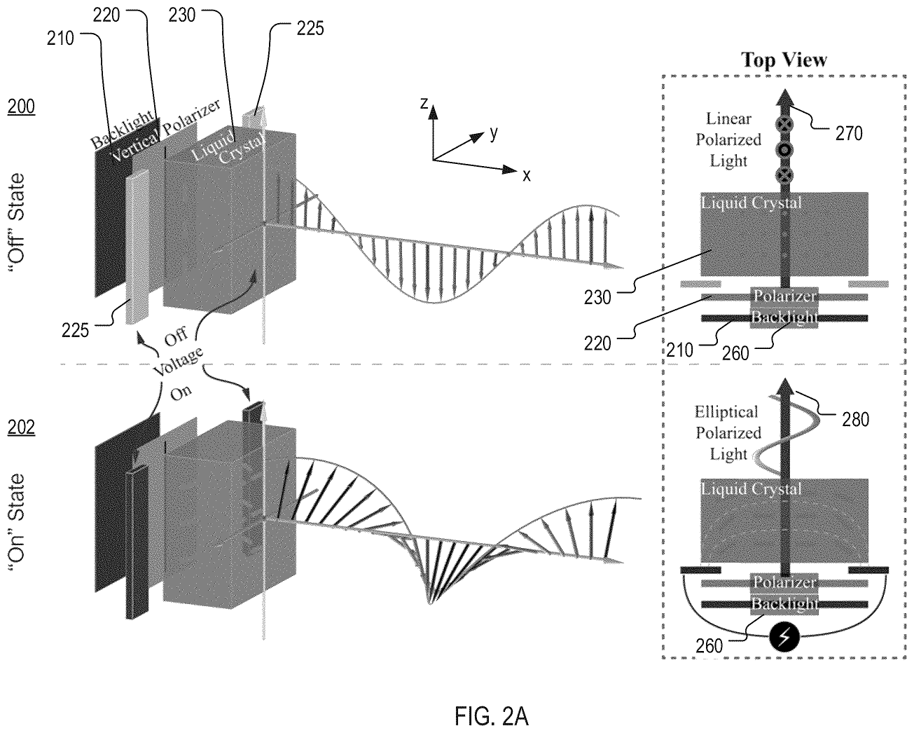

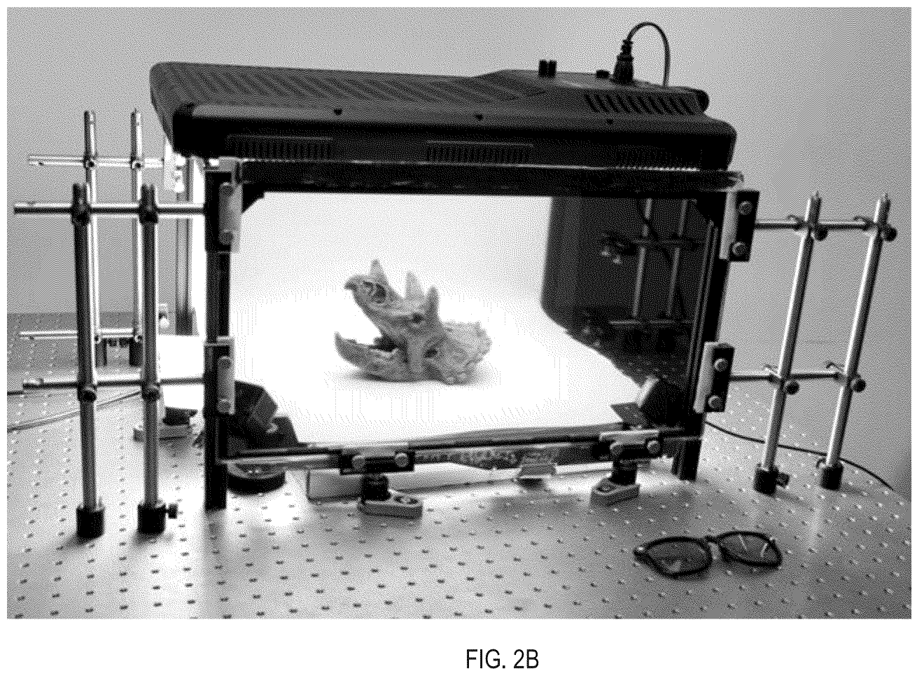

Referring to FIG. 2A, the liquid crystal (LC) layer may control each individual pixel unit's liquid crystal arrangement by adding different voltage to it, so as to modify the polarization state of the linear polarized light passing through the liquid crystal layer. Behind the LC layer 230, it has a linear polarizer film 220 attached to the back (i.e., a negative x direction), which only allows the linear polarized light from back light 210 to pass the film by blocking the unpolarized backlight. Each pixel unit of the LC layer has a pair of electrodes 225, and by adding different voltage at the electrodes, the liquid crystal is twisted into certain orientation. Therefore, the linear polarized light's polarization is modified (or called as modulated) according to a fast axis and a slow axis of the liquid crystal.

When the pixel unit is in an “off” state, as shown in 200 in FIG. 2A, there is no voltage applied to the electrodes, a linear polarized light 260 is not modified, and the output from the pixel unit is still linearly polarized with same polarization (linear polarized light 270). When the pixel unit is in an “on” state, as shown in 202 in FIG. 2A, there is a non-zero voltage applied to the electrodes, a linear polarized light 260 is modified, and the output from the pixel unit is elliptical polarized (elliptical polarized light 280).

In some implementations, in response to the control voltage applied on the pixel being non-zero, the pixel of the liquid crystal layer is configured to change a polarization state of the polarized light to an elliptical polarized state; and in response to the control voltage applied on the pixel being zero, the pixel of the liquid crystal layer is configured to maintains the polarization state of the polarized light.

In some implementations, referring back to FIG. 1A, a color mask filter (not shown in the figure) may be disposed in front of the LC layer (i.e., at positive x direction). The color mask filter may have a color mask filter array (or referred as color pixel array) precisely align with the liquid crystal pixel array in the LC layer, so only one color can pass the filter for each pixel unit. In some implementations, the color mask filter may have a plurality of primary colors, for example, three primary colors including red, green and blue.

In some other implementations, the color mask filter may be disposed on back of the LC layer (i.e., at negative x direction).

In some implementations, the LC layer 134 or the AR glass panel 130 may be similar to a device which is converted from normal high-resolution monitor and/or glasses is made from off-the-shelf polarization film. Therefore, the embodiments in the present disclosure may have benefits such as low-cost, wide availability, and/or a proven record of high quality and reliability.

Since human eye is not sensitive to a polarization state of a polarized light, a human being, with naked eyes, can only see the light intensity, and is not be able to see this modulation to the light's polarization state modified by the LC layer. Therefore, without any additional device, the AR display would be viewed as normal glass without displaying AR content on it to naked eyes, as shown in FIG. 2B.

Referring back to FIG. 1A, to see the modulated polarization state of the light modified by the LC layer, wherein the modulation corresponds to the AR content, a user 145 may wear a pair of eyeglasses (e.g., polarization glasses) including a second linear polarizer 140. The second linear polarizer 140 and the linear polarizer 132 have polarization difference between each other. This polarization difference may be a fixed value, for non-limiting examples, about 45-degree, about 60-degree, about 80-degree, or about 90-degree polarization difference between each other. Here, “about” a value may refer to a range of within 5% of the value, i.e., a range between 95% and 105% of the value.

In some implementations, the first linear polarizer and the second linear polarizer may have a substantial 90-degree polarization difference to each other. For non-limiting examples, the linear polarizer 132 may have a vertical polarization (along z axis) and the second linear polarizer 140 may have a horizontal polarization (along y axis), or the linear polarizer 132 may have a horizontal polarization (along y axis) and the second linear polarizer 140 may have a vertical polarization (along z axis), or the linear polarizer 132 may have a 45-degree polarization relative to positive y-direction and the second linear polarizer 140 may have a 135-degree polarization relative to the positive y-direction.

The eyeglasses are configured to directly receive the modified polarized light from LC layer (or directly receive light from the color filters when the color filters are used). The linear polarization of the second linear polarizer in the eyeglasses only passes the component which parallel to the second linear polarizer and block the perpendicular component. Thus, the user can see the AR content, which corresponds to the polarization state of the light modified by the voltages applied on pixel units of the LC layer.

In some implementations, only one lens of the eyeglasses comprises the second linear polarizer; and the other lens of the eyeglasses is a normal glass, so that only one eye of the user can see the AR content and the other eye of the user is unable to see the AR content.

In some implementations, one lens of the eyeglasses comprises the second linear polarizer, and another lens of the eyeglasses comprises a third linear polarizer; and the second linear polarizer and the third linear polarizer have same polarization. So that both eyes of the user can see the AR content.

The eyeglasses in the present disclosure may be compared to 3D glasses which are used to watch 3D movies; and they are very different. At least one difference includes: the 3D glasses for watching 3D movies have different polarizer for the two lenses, for example, having opposite polarizer for the two lens such as left and right circularly polarized for left and right eyes, respectively); while the eyeglasses in the present disclosure have polarizer in only one lens (the other lens does not have polarizer), or have same linear polarization for both lenses.

For a better visual experience, various embodiments may include an alignment functionality to display the augmented reality content based on viewer and object position. In some implementations, at least one camera (e.g., two cameras) on the back of the AR display to perform this, wherein cameras may capture the object, the AR display, and the user (viewer) in the front, and use stereo reconstruction methods to recover a corresponding 3D model. In some implementations, a gray code may be displayed on the AR screen and the screen images may be captured with the cameras. When the gray code is decoded, each pixel on the screen are aligned to each camera coordinate and all the pixels are triangulated in 3D. In some implementations, the cameras may be kept “on” (i.e., open state or capturing state) when the user is watching the AR display. A real-time face detection method may be performed by both cameras or a controller and the face position in 3D from these two cameras is triangulated by both cameras or a controller. So, the location of the viewer, AR-screen, and objects are all under the camera coordinate. Based on the view position and orientation, the viewing direction to the subject may be traced and the AR content may be rendered according to the intersection of the view ray (or light from the object to the user) and the AR panel (or AR screen). Thus, the user may see the aligned AR content when the user is moving in front of the AR panel without substantial misalignment.

In some implementations, when the controller is configured to render the AR content based on the stereo reconstruction, the controller is configured to determine the control voltages on a plurality of liquid crystal pixels in the liquid crystal layer, so as to display the AR content on the AR panel. In some implementations, when there is no AR content displayed on a set of liquid crystal pixels, the control voltages on the set of liquid crystal pixels may be zero; when there is AR content displayed on another set of liquid crystal pixels, the control voltages on the other set of liquid crystal pixels may be non-zero. The controller may determine which pixel belongs to which set, and also determine values of the control voltages for the set of pixels having non-zero control voltage.

In various embodiments, the device 100 may further tracks positions of a user's face, so as to render the AR content on the AR panel based on the face positions, when the user is at a different position (e.g., position1 or postion2), as shown in FIG. 1B. The device may include a portion or all of the following: at least one camera 170, and a controller. The at least one camera may be configured to acquire at least one image of the user to obtain a face position of the user. The controller is configured to be in communication with the camera 170 and the AR panel 130, and may be configured to render the AR content based on the face position.

In some implementations, the controller is configured to perform stereo reconstruction of the face position with respect to the object; and/or the controller is configured to render the AR content based on the stereo reconstruction.

In some implementations, the at least one camera 170 may acquire an image in front of the AR panel and/or perform a face recognition/position to obtain a user's face position based on the acquired image. The face recognition/position algorithm may be based on the eyeglasses worn by the user.

In some implementations, the at least one camera 170 may acquire at least one image in front of the AR panel and transmit the acquired image(s) to the controller via either wired communication or wireless communication. The controller may perform a face recognition/position to obtain a user's face position based on the acquired image(s). The face recognition/position algorithm may be based on the eyeglasses worn by the user.

In some implementations, the controller may perform stereo reconstruction of the face position with respect to the object based on the face location of the user and the location of the object. For example, when the user is at position1, the light 152 is transmitted from the object 120 to the user 145, and the controller may reconstruct a display position 162 on the AR panel where the light 153 passes through the AR panel; and when the user is at position2, the light 153 is transmitted from the object 120 to the user 145, and the controller may reconstruct a display position 163 on the AR panel where the light 153 passes through the AR panel.

Based on the stereo reconstruction including the reconstructed display position, the controller is configured to render the AR content, so that the AR content overlays on the correct location on top of the object in the real background/environment. For example, the controller sends data to the AR panel to display text/graphic information about the object on the AR display using the display position 162 or 163 as reference point when the user is at position1 or position2, respectively.

In some implementations, the at least one camera may be one single camera, which may be disposed on opposite side from the object 120 with respect to the AR panel, as shown in FIG. 1B. In some implementations, the single camera may be disposed on same side as the object 120 with respect to the AR panel (not shown in FIG. 1B), i.e., the single camera and the object are at the negative x-direction with respect to the AR panel. The single camera may be capable of measuring a distance of the user relative to the camera, so that a 3D stereo reconstruction may be performed.

In some implementations, the at least one camera may include two or more cameras, which may be disposed on same side or different side to each other with respect to the AR panel. For non-limiting example, there may be two cameras. The two cameras can both be disposed on the “front” side of the AR display (i.e., positive x direction with respect to the AR panel), or can both be disposed at the “back” side of the AR display (i.e., negative x direction with respect to the AR panel); or one of the two cameras can be disposed at positive x direction with respect to the AR panel and another camera can be disposed at negative x direction with respect to the AR panel. Each of the two camera may acquire at least one image of the user and/or the object; and with two cameras' known position, a 3D stereo reconstruction may be performed.

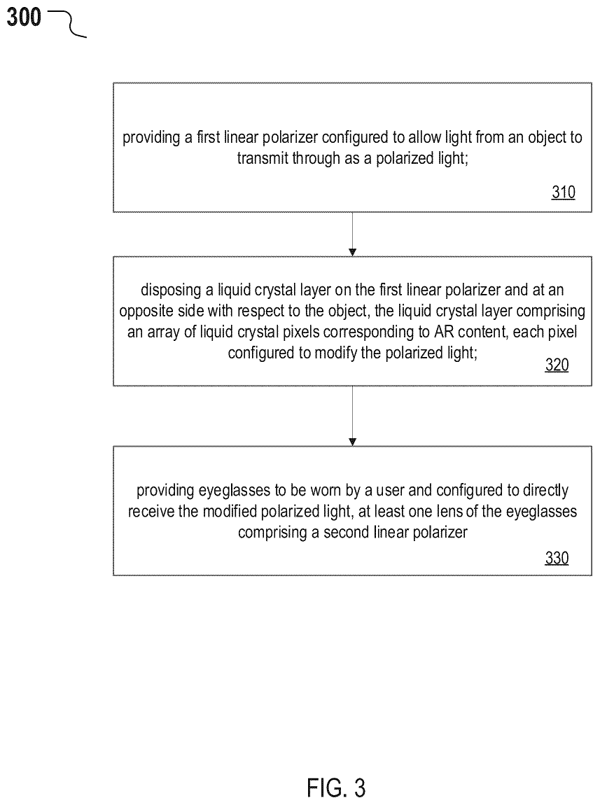

FIG. 3 shows a flow diagram of a method 300 for providing an augmented reality (AR) display. The method 300 may include a portion or all of the following steps: step 310: providing a first linear polarizer configured to allow light from an object to transmit through as a polarized light; step 320: disposing a liquid crystal layer on the first linear polarizer and at an opposite side with respect to the object, the liquid crystal layer comprising an array of liquid crystal pixels corresponding to AR content, each pixel configured to modify the polarized light; and/or step 330: providing eyeglasses to be worn by a user and configured to directly receive the modified polarized light, at least one lens of the eyeglasses comprising a second linear polarizer.

In some implementations, one lens of the eyeglasses comprises the second linear polarizer; and/or the first linear polarizer and the second linear polarizer have polarization difference between each other. This polarization difference may be a fixed value, for non-limiting examples, about 45-degree, about 60-degree, about 80-degree, or about 90-degree polarization difference between each other. Here, “about” a value may refer to within 5% of the value, i.e., a range between 95% and 105% of the value. In some implementations, the first linear polarizer and the second linear polarizer may have a substantial 90-degree polarization difference to each other.

In some implementations, the first linear polarizer has horizontal polarization; and/or the second linear polarizer has vertical polarization.

In some implementations, one lens of the eyeglasses comprises the second linear polarizer, and another lens of the eyeglasses comprises a third linear polarizer; and/or the second linear polarizer and the third linear polarizer have same polarization. The first linear polarizer and the second linear polarizer have polarization difference between each other. This polarization difference may be a fixed value, for non-limiting examples, about 45-degree, about 60-degree, about 80-degree, or about 90-degree polarization difference between each other. Here, “about” a value may refer to within 5% of the value, i.e., a range between 95% and 105% of the value. In some implementations, the first linear polarizer and the second linear polarizer may have a substantial 90-degree polarization difference to each other.

In some implementations, the device may include a color filter layer comprising color pixels, and each color pixel is configured to be aligned with each liquid crystal pixel in the liquid crystal layer.

In some implementations, each pixel of the liquid crystal layer is configured to modify the polarized light according to a control voltage applied on the pixel.

In some implementations, in response to the control voltage applied on the pixel being non-zero, the pixel of the liquid crystal layer is configured to change a polarization state of the polarized light to an elliptical polarized state; and/or in response to the control voltage applied on the pixel being zero, the pixel of the liquid crystal layer is configured to maintains the polarization state of the polarized light.

In some implementations, the method may further include providing at least one camera configured to acquire at least one image of the user to obtain a face position of the user; and/or providing a controller configured to render the AR content based on the face position.

In some implementations, the controller is configured to perform stereo reconstruction of the face position with respect to the object; and/or the controller is configured to render the AR content based on the stereo reconstruction.

In some implementations, the method may further include using the at least one camera to capture the object, the AR display, and the user (viewer), and performing stereo reconstruction to recover a corresponding 3D model.

In some implementations, the method may further include a portion or all of the following: displaying a gray code on the AR panel/screen and capturing the panel/screen images with the cameras; decoding the gray code; aligning each pixel on the screen to each camera coordinate and triangulating all the pixels in 3D; performing a real-time face detection and triangulating the face position in 3D. So, the location of the viewer, AR-screen, and objects are all under the camera coordinate. In some implementations, the cameras may be kept “on” (i.e., open state or capturing state) when the user is watching the AR display.

In some implementations, the method may further include a portion or all of the following: based on the view position and orientation, tracing a viewing direction to the subject; and/or rendering the AR content according to the intersection of the view ray (or light from the object to the user) and the AR panel (or AR screen). Thus, the user may see the aligned AR content when the user is moving in front of the AR panel without substantial misalignment.

The present disclosure also describes various embodiments, wherein a system provides an AR display, the system may include a portion or all of the embodiments or implementation described in the present disclosure.

In some implementations, a system may include a portion or all of the following: a panel comprising: a first linear polarizer configured to allow light from an object to transmit through as a polarized light; and a liquid crystal layer disposed on the first linear polarizer and at an opposite side with respect to the object, the liquid crystal layer comprising an array of liquid crystal pixels corresponding to AR content, each pixel configured to modify the polarized light; eyeglasses worn by a user and configured to directly receive the modified polarized light, at least one lens of the eyeglasses comprising a second linear polarizer; at least one camera configured to acquire at least one image of the user to obtain a face position of the user; and/or a controller configured to render the AR content based on the face position.

In some implementations, the controller is configured to perform stereo reconstruction of the face position with respect to the object; and/or the controller is configured to render the AR content based on the stereo reconstruction.

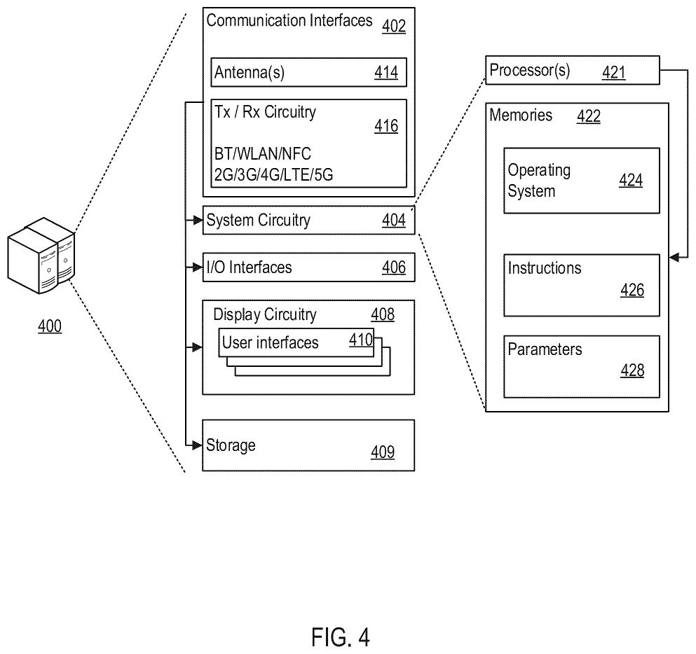

FIG. 4 shows an example of an electronic device 400 to implement one or more method described in the present disclosure. In some implementations, the electronic device 400 may be used to be a portion of the device/system described in the present disclosure.

In one implementation, the electronic device 400 may be a portion or an entirety of a computer, a server, a laptop, or a mobile device. In another implementation, the electronic device 400 may be a set of electronic devices comprising at least one of one or more computing server, one or more data server, one or more network server, one or more terminal, one or more laptop, and/or one or more mobile device. In some implementations, the controller, a portion of the camera, and/or a portion of the AR panel may include a portion or all of components included in the electronic device 400 as described in the present disclosure.

The electronic device 400 may include communication interfaces 402, a system circuitry 404, an input/output interfaces (I/O) 406, a display circuitry 408, and a storage 409. The display circuitry may include a user interface 410. The system circuitry 404 may include any combination of hardware, software, firmware, or other logic/circuitry. The system circuitry 404 may be implemented, for example, with one or more systems on a chip (SoC), application specific integrated circuits (ASIC), discrete analog and digital circuits, and other circuitry. The system circuitry 404 may be a part of the implementation of any desired functionality in the electronic device 400. In that regard, the system circuitry 404 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 410. The user interface 410 and the inputs/output (I/O) interfaces 406 may include a graphical user interface, touch sensitive display, haptic feedback or other haptic output, voice or facial recognition inputs, buttons, switches, speakers and other user interface elements. Additional examples of the I/O interfaces 406 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 4, the communication interfaces 402 may include wireless transmitters and receivers (“transceivers”) and any antennas used by the transmitting and receiving circuitry of the transceivers. The communication interfaces 402 may also include wireline transceivers, which may provide physical layer interfaces for any of a wide range of communication protocols, such as any type of Ethernet, data over cable service interface specification (DOCSIS), digital subscriber line (DSL), Synchronous Optical Network (SONET), or other protocol. The communication interfaces 402 may include a Radio Frequency (RF) transmit (Tx) and receive (Rx) circuitry 416 which handles transmission and reception of signals through one or more antennas 414. The communication interface 402 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 402 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 404 may include hardware, software, firmware, or other circuitry in any combination. The system circuitry 404 may be implemented, for example, with one or more systems on a chip (SoC), application specific integrated circuits (ASIC), microprocessors, discrete analog and digital circuits, and other circuitry. For example referring to FIG. 4, the system circuitry 404 may include one or more processors 421 and memories 422. The memory 422 stores, for example, an operating system 424, instructions 426, and parameters 428. The processor 421 is configured to execute the instructions 426 to carry out desired functionality for the electronic device 400. The parameters 428 may provide and specify configuration and operating options for the instructions 426. The memory 422 may also store any BT, WiFi, 3G, 4G, 5G or other data that the electronic device 400 will send, or has received, through the communication interfaces 402. In various implementations, a system power for the electronic device 400 may be supplied by a power storage device, such as a battery or a transformer.

The storage 409 may be used to store various initial, intermediate, or final data. In one implementation, the storage 409 may be integral with a database server. The storage 409 may be centralized or distributed, and may be local or remote to the electronic device 400. For example, the storage 409 may be hosted remotely by a cloud computing service provider.

The present disclosure describes various embodiments, which may be implemented, partly or totally, on the one or more electronic device described in FIG. 4.

In some implementations, one way to make the AR panel described in the present disclosure may be starting from a commercial LCD monitor, which may be constructed with a LC layer, a color filter and two linear polarization filters. One linear polarization filter is on the back and the other linear polarization filter is in the front. These two linear polarization filters have linear polarization being perpendicular to each other. The method may include taking off the front polarization film, which is normally glued to a protection glass with the color mask; using cleaning detergent (e.g., acetone) to wipe out all the remaining glue after tearing down the front polarization film to make the panel clean. The panel may be configured to connect to an electronic device (e.g., desktop or micro-computer) for power and display AR content.

In some implementations, the AR panel may be constructed with any types of liquid crystal display (e.g., twisted nematic (TN), in-plane switching (IPS), vertical alignment (VA), or etc.), or some other display method such as OLED.

In some implementations, any portion of the various embodiments in the present disclosure may be combined with other methods such as smart glass, beam splitter to create other display or AR effects.

The various embodiments in the present disclosure may address one or more issues/problem associated with AR display, leading to a plurality of benefits, for example but not limited to, displaying much higher quality AR content than some present AR technology (e.g., some present AR glasses), low-cost, and/or easy to manufactory.

The various embodiments in the present disclosure may have at least one of the following advantages, in compared with present AR glasses. One advantage may include not requiring additional computing power on the user's side, wherein normal AR glasses require onboard computing to estimate user 3D location and orientation and render the content for display, both of which are high power consumption, so the present AR glasses may not work for time-consuming tasks. Another advantage may include not having specialized requirement on the eyeglasses side, so that the eyeglasses may be made with ultra-light weight, while the present AR glasses still requires large form factors. Another advantage may include not inducing any potential harmful to human eye and not causing eye stress for long-time usage, since, different from some AR glasses, the AR content in the present disclosure is not displayed at near-eye distance.

In the embodiments and implementation of this disclosure, any components in a described apparatus/system or any steps in a described method may be combined or arranged in any amount or order, as desired. Two or more of the components or steps may be included or performed in parallel. Embodiments and implementations in the disclosure may be used separately or combined in any order.

The techniques described above, may be implemented as computer software using computer-readable instructions and physically stored in one or more computer-readable media. For example, human accessible storage devices and their associated media include such as optical media including CD/DVD ROM/RW with CD/DVD or the like media, thumb-drive, removable hard drive or solid state drive, legacy magnetic media such as tape and floppy disc, specialized ROM/ASIC/PLD based devices such as security dongles, and the like. Those skilled in the art may also understand that term “computer readable media” as used in connection with the presently disclosed subject matter does not encompass transmission media, carrier waves, or other transitory signals.

The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

While the particular invention has been described with reference to illustrative embodiments, this description is not meant to be limiting. Various modifications of the illustrative embodiments and additional embodiments of the invention will be apparent to one of ordinary skill in the art from this description. Those skilled in the art will readily recognize that these and various other modifications can be made to the exemplary embodiments, illustrated and described herein, without departing from the spirit and scope of the present invention. It is therefore contemplated that the appended claims will cover any such modifications and alternate embodiments. Certain proportions within the illustrations may be exaggerated, while other proportions may be minimized. Accordingly, the disclosure and the figures are to be regarded as illustrative rather than restrictive.

What is claimed is:

1. An apparatus for providing an augmented reality (AR) display, the apparatus comprising:
a first linear polarizer configured to allow light from an object to transmit through as a polarized light;
a liquid crystal layer disposed on the first linear polarizer and at an opposite side with respect to the object, the liquid crystal layer comprising an array of liquid crystal pixels corresponding to AR content, each pixel configured to modify the polarized light; and
eyeglasses worn by a user and configured to directly receive the modified polarized light, at least one lens of the eyeglasses comprising a second linear polarizer.

2. The apparatus according to claim 1, wherein:
one lens of the eyeglasses comprises the second linear polarizer.

3. The apparatus according to claim 2, wherein:
the first linear polarizer and the second linear polarizer have a polarization difference between each other.

4. The apparatus according to claim 1, wherein:
one lens of the eyeglasses comprises the second linear polarizer, and another lens of the eyeglasses comprises a third linear polarizer; and
the second linear polarizer and the third linear polarizer have same polarization.

5. The apparatus according to claim 4, wherein:
the first linear polarizer and the second linear polarizer have a polarization difference between each other.

6. The apparatus according to claim 1, further comprising:
a color filter layer comprising color pixels aligned with the liquid crystal pixels in the liquid crystal layer.

7. The apparatus according to claim 1, wherein:
each pixel of the liquid crystal layer is configured to modify the polarized light according to a control voltage applied on the pixel.

8. The apparatus according to claim 7, wherein:
in response to the control voltage applied on the pixel being non-zero, the pixel of the liquid crystal layer is configured to change a polarization state of the polarized light to an elliptical polarized state; and
in response to the control voltage applied on the pixel being zero, the pixel of the liquid crystal layer is configured to maintains the polarization state of the polarized light.

9. The apparatus according to claim 1, further comprising:
at least one camera configured to acquire at least one image of the user to obtain a face position of the user; and
a controller configured to render the AR content based on the face position.

10. The apparatus according to claim 9, wherein:
the controller is configured to perform stereo reconstruction of the face position with respect to the object; and
the controller is configured to render the AR content based on the stereo reconstruction.

11. The apparatus according to claim 10, wherein, when the controller is configured to render the AR content based on the stereo reconstruction, the controller is configured to determine a subset of the liquid crystal pixels in the liquid crystal layer, on each of which a control voltage is applied.

12. A method for providing an augmented reality (AR) display, the method comprising:
providing a first linear polarizer configured to allow light from an object to transmit through as a polarized light;
disposing a liquid crystal layer on the first linear polarizer and at an opposite side with respect to the object, the liquid crystal layer comprising an array of liquid crystal pixels corresponding to AR content, each pixel configured to modify the polarized light; and
providing eyeglasses to be worn by a user and configured to directly receive the modified polarized light, at least one lens of the eyeglasses comprising a second linear polarizer.

13. The method according to claim 12, wherein:
one lens of the eyeglasses comprises the second linear polarizer.

14. The method according to claim 13, wherein:
the first linear polarizer and the second linear polarizer have a polarization difference between each other.

15. The method according to claim 12, further comprising:
disposing a color filter layer comprising color pixels to be aligned with the liquid crystal pixels in the liquid crystal layer.

16. The method according to claim 12, wherein:
each pixel of the liquid crystal layer is configured to modify the polarized light according to a control voltage applied on the pixel.

17. The method according to claim 16, wherein:
in response to the control voltage applied on the pixel being non-zero, the pixel of the liquid crystal layer is configured to change a polarization state of the polarized light to an elliptical polarized state; and
in response to the control voltage applied on the pixel being zero, the pixel of the liquid crystal layer is configured to maintains the polarization state of the polarized light.

18. The method according to claim 12, further comprising:
providing at least one camera configured to acquire at least one image of the user to obtain a face position of the user; and
providing a controller configured to render the AR content based on the face position.

19. A system for providing an augmented reality (AR) display, the system comprising:
a panel comprising:
a first linear polarizer configured to allow light from an object to transmit through as a polarized light; and
a liquid crystal layer disposed on the first linear polarizer and at an opposite side with respect to the object, the liquid crystal layer comprising an array of liquid crystal pixels corresponding to AR content, each pixel configured to modify the polarized light;
eyeglasses worn by a user and configured to directly receive the modified polarized light, at least one lens of the eyeglasses comprising a second linear polarizer;
at least one camera configured to acquire at least one image of the user to obtain a face position of the user; and
a controller configured to render the AR content based on the face position.

20. The system according to claim 19, wherein:
the controller is configured to perform stereo reconstruction of the face position with respect to the object; and
the controller is configured to render the AR content based on the stereo reconstruction.
